(19) United States
(12) Patent Application Publication
(10) Pub. No.: US 2018/0210633 A1
(43) Pub. Date: Jul. 26, 2018

(54) GENERATING AND PROVIDING THEMES FOR MAPS

(71) Applicant: Microsoft Technology Licensing, LLC, Redmond, WA (US)

(72) Inventors: David Grochocki, JR., Seattle, WA (US); Ana Lilia Otero Diaz, Woodinville, WA (US); Jeff West, Sammamish, WA (US); Kshitij Mehta, Bothell, WA (US); Elizabeth P. Salowitz, Seattle, WA (US)

(21) Appl. No.: 15/411,609

(22) Filed: Jan. 20, 2017

(51) Int. Cl. G06F 3/0484; G06F 17/30

(52) U.S. Cl. CPC G06F 3/04845; G06F 17/30247; G06F 3/0482; G06F 17/30274; G06F 17/30241

(57) ABSTRACT

A user interface is provided that allows a user to customize features, and attributes of features, of a map displayed by a map application. The features may include roads, buildings, parks, bodies of water, specific types of businesses (e.g., restaurants, drug stores, hospitals, banks), etc. The attributes of a feature may include colors, graphics, and fonts that are used to display the associated feature on the map. The user interface allows the user to customize the attributes and features, and to save the customized attributes and features as a theme. The theme can then be enabled or disabled by the user for a map, and can be distributed or shared by the user through a theme marketplace. The theme marketplace may allow users to browse available themes which may be made available for free or for purchase.

### BACKGROUND

Map applications are a popular type of application, with a variety of uses. For example, a user may use a map application to determine directions, or may use the map application to determine restaurants, banks, drug stores, and other businesses near a current location. Map applications are commonly integrated into smart phones, tablets, and vehicle navigation systems, and may be accessed by any computing device though the Internet.

While such map applications are ubiquitous, there currently is no easy way for users to customize the look and feel of map applications. For example, a user may desire to change the font, colors, and graphics used by the map application on their smart phone, but there currently is no easy way for the user to make such changes.

### SUMMARY

A user interface is provided that allows a user to customize features, and attributes of features, of a map displayed by a map application. The features may include roads, buildings, parks, bodies of water, specific types of businesses (e.g., restaurants, drug stores, hospitals, and banks), etc. The attributes of a feature may include colors, graphics, and fonts that are used to display the associated feature on the map. The user interface allows the user to customize the attributes and features, and to save the customized attributes and features as a theme. The theme can then be enabled or disabled by the user for a map, and can be distributed or shared by the user through a theme marketplace. The theme marketplace may allow users to browse available themes which may be made available for free or for purchase.

In an implementation, a system for customizing map features, generating a theme using the customized features, and for distributing the theme is provided. The system includes at least one computing device and a map engine. The map engine may be adapted to: receive a map comprising a plurality of features, wherein each feature comprises a plurality of attributes; provide a user interface through which a user can change a subset of the features of the plurality of features; receive a change to at least one feature of the subset of features, wherein the change includes at least one custom attribute; generate a theme including the change to the at least one feature; and display the map with the generated theme.

In an implementation, a system for customizing map features, generating a theme using the customized features, and for distributing the theme is provided. The system may include at least one computing device and a map engine. The map engine may be adapted to: receive a map comprising a plurality of features, wherein each feature comprises a plurality of attributes; provide a user interface through which a user can browse a plurality of themes, wherein each theme comprises a change to at least one feature of the subset of features, and wherein the change includes at least one custom attribute for the at least one feature; receive a selection of at least one theme of the plurality of themes; and display the map with the selected at least one theme.

In an implementation, a method for customizing map features, generating a theme using the customized features, and for distributing the theme is provided. The method includes: providing a user interface through which a user can change a subset of the features of a plurality of features of a map by a computing device, wherein each feature comprises a plurality of attributes; receiving a change to at least one feature of the subset of features by the computing device, wherein the change includes at least one custom attribute; generating a theme including the change to the at least one feature of the subset of features by the computing device, wherein the theme is associated with a temporal condition; and displaying the map with the generated theme by the computing device. Displaying the map by the computing device may include: when a current date or time satisfies the temporal condition, displaying the map with the at least one feature of the subset of features using the at least one custom attribute; and when the current date or time does not satisfy the temporal condition, displaying the map with the at least one feature of the subset of features without using the at least one custom attribute.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is an illustration of an exemplary environment for generating and distributing themes for a map application;

FIG. 2 is an illustration of an implementation of an exemplary map engine;

FIG. 3 is an illustration of an example user interface for viewing a map;

FIGS. 4 and 5 are illustrations of example user interfaces that may be used to generate a theme for a map;

FIG. 6 is an illustration of an example user interface for viewing a map;

FIG. 7 is an illustration of an example user interface for browsing and downloading themes;

FIG. 8 is an operational flow of an implementation of a method for generating a theme for a map, and distributing the theme on a theme marketplace;

FIG. 9 is an operational flow of an implementation of a method for selecting a theme for a map from a theme marketplace, and for displaying the map with the selected theme;

FIG. 10 is an operational flow of an implementation of a method for displaying a map with or without a received theme based on a temporal condition; and

FIG. 11 shows an exemplary computing environment in which example embodiments and aspects may be implemented.

### DETAILED DESCRIPTION

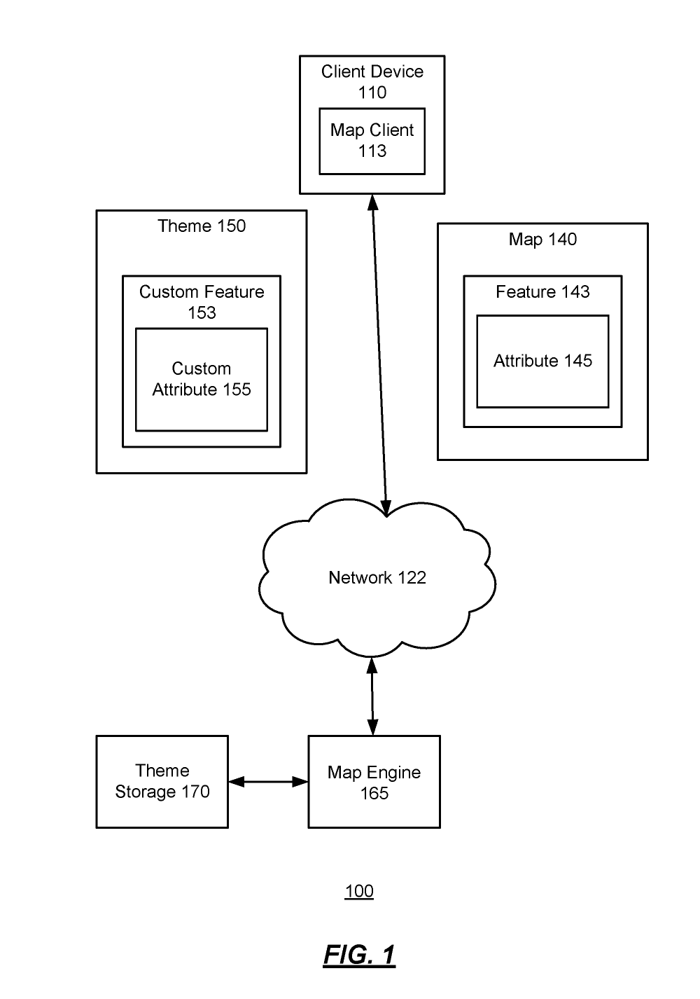

FIG. 1 is an illustration of an exemplary environment 100 for generating and distributing themes for a map application. As used herein, map application may refer to any application that directly or indirectly incorporates a map into the application. Example applications may include ride sharing applications, weather applications, social networking applications, gaming applications, and any other application that displays a map. The environment 100 may include a map engine 165 and one or more client devices 110 in communication through a network 122. The network 122 may be a variety of network types including the public switched telephone network (PSTN), a cellular telephone network, and a packet switched network (e.g., the Internet). Although only one client device 110 and one map engine 165 are shown in FIG. 1, there is no limit to the number of client devices 110 and map engines 165 that may be supported.

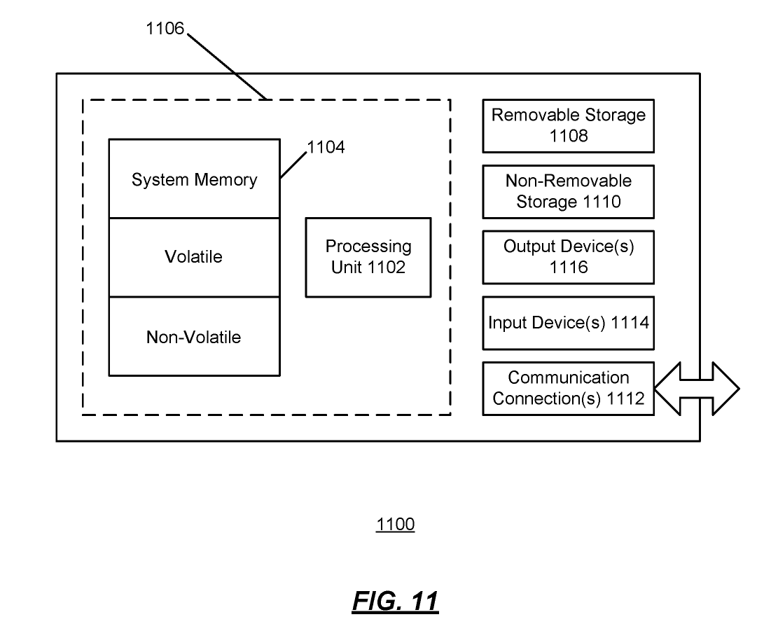

The client device 110 and the map engine 165 may be implemented using a variety of computing devices such as smart phones, desktop computers, laptop computers, tablets, vehicle navigation systems, and video game consoles. Other types of computing devices may be supported. A suitable computing device is illustrated in FIG. 11 as the computing device 1100.

Each client device 110 may further include a map client 113. The map client 113 may be used by a user of the client device 110 to view and interact with one or more maps 140. Depending on the implementation, the map client 113 may be, or may be part of or comprised within, a map application. An example map application is the map application integrated into most smart phones and tablet computers.

A map 140 may include a plurality of features 143. The features 143 of a map 140 may include roads, buildings, bodies of water, mountain ranges, parks, forests, the current or starting location of the user, a destination location, and any other place or thing that is typically rendered on a map 140. The features 143 may also include particular types of businesses or entities such as hospitals, supermarkets, restaurants, dry cleaners, drug stores, school, libraries, and community centers. Other features 143 may be supported.

Depending on the implementation, the features 143 may further include functional aspects of the map 140. These functional aspects may include user interface elements such as search bars that users may use to provide queries such as addresses, zoom sliders that users may use to adjust the zoom level of the map 140, and controls that users may use to move or rotate the map 140, or to change a perspective used to view the map 140. Other features such as audio and video features 143 may be supported. For example, a map 140 may include audio such as background music or sound effects that are played when certain events take place on the map 140.

Each feature 143 may have one or more attributes 145. The attributes 145 for a feature 143 may include the icons or graphics associated with the feature 143, the color of the icons, the size of the icons, any animations associated with the icons, and other information such as how the icons behave when selected or interacted with. The attributes 145 for a feature 143 may include fonts (including colors and sizes) that are used to display any text associated with the feature 143. Any type of attributes 145 may be supported.

The map engine 165 may allow users to customize one or more features 143 and/or attributes 145 for a map 140 using one or more themes 150. A theme 150 for a map 140 may replace one or more features 143 or attributes 145 for the map 140 with one or more custom features 153 or custom attributes 155.

The map engine 165 may provide a user interface that displays some or all of the features 143 that are associated with the map 140. The user may select a feature 143, and the map engine 165 may display the attributes 145 that are currently associated with the selected feature 143. These features 143 may be the default features 143 that used to display the map 140. The user may select an attribute 145, and may provide a custom attribute 155 for the selected attribute 145.

For example, for a feature 143 such as a road, the user may select an attribute 145 such as the icon or graphic that is used to represent the road on the map 140. The user may be presented with one or more “pre-selected” alternative graphics for the road, or the user may upload or provide their own custom graphic. The selected (i.e., “pre-selected”) alternative graphic or provided custom graphic may be used as the custom attribute 155.

The user may provide custom features 153 for the map 140. For example, a map 140 may currently only include features 143 for certain types of businesses such as restaurants, bars, and drug stores. However, the user would like to design a theme 150 related to doughnuts, and may provide a custom feature 153 for businesses that sell doughnuts. The user may provide custom attributes 155 for the custom feature 153 such as a doughnut icon that is displayed on the map, and a doughnut themed font that may be used to display the name of the doughnut selling business.

After creating a theme 150 for a map 140, the map engine 165 may store the generated theme in theme storage. The user may load the theme using the map client 113, and the map 140 may be displayed by the map client 113 such that the features 143 and/or attributes 145 of the map 140 are displayed using the custom features 153 and/or custom attributes 155 of the theme 150.

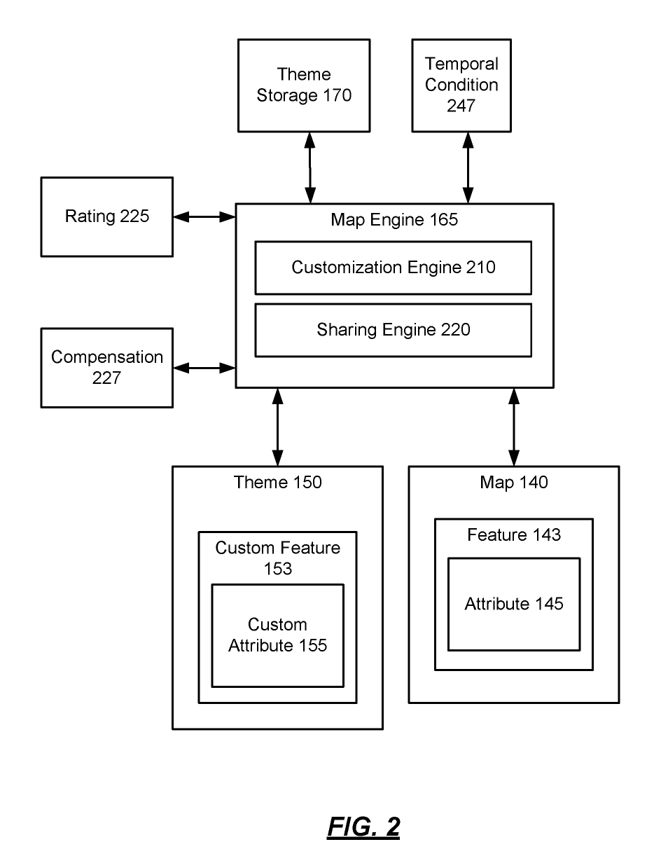

FIG. 2 is an illustration of an implementation of an exemplary map engine 165. The map engine 165 may include one or more components including a customization engine 210 and a sharing engine 220. More or fewer components may be included in the map engine 165. Some or all of the components of the map engine 165 may be implemented by one or more computing devices such as the computing device 1100 described with respect to FIG. 11. In addition, some or all of the functionality attributed to the map engine 165 may be performed by the map client 113, and vice versa.

The customization engine 210 may allow a user to create theme 150 for a map 140. In some implementations, the customization engine 210 may provide an application or a user interface through which the user may create a desired theme 150. The user may create a theme 150 by providing or selecting custom features 153 and/or custom attributes 155 for the theme 150. The user may provide a name for the theme 150, and the generated theme 150 may be stored by the customization engine 210 in the theme storage 170.

With respect to custom features 153, the customization engine 210 may allow the user to create or define custom features 153 for the theme 150. A custom feature 153 may be a feature that is not found in the default or stock version of the map 140. As described previously, the features 143 of the map 140 may include features such as roads, buildings, lakes, parks, streams, and other features that are typically associated with a map 140. However, depending on the theme 150 that is being created, a user may desire to define and include custom features 153 to include in the theme 150.

For example, a user may be generating a “garage sale” theme 150 to show the locations of the garage sales that are scheduled for a weekend. Because there currently does not exist a garage sale feature 143, the user may use the customization engine 210 to create a custom feature 153 that can be used to represent a garage sale on the map 140. The user may use the customization engine 210 to define custom attributes 155 for the garage sale custom feature 153 such a dollar sign graphic that is displayed on the map 140, and a font that is used to display the address and other text that may be associated with the garage sale feature 143.

In another example, a hypothetical car company called “Smith Motor Company” may be generating a theme 150 to show the locations of Smith Motor Company dealerships. Because there currently does not exist a feature 143 that corresponds to car dealerships or more specifically Smith Motor Company dealerships, the user may use the customization engine 210 to create a custom feature 153 that can be used to represent Smith Motor Company dealerships on the map 140. The user may use the customization engine 210 to define custom attributes 155 such a logo of the Smith Motor Company that is displayed on the map 140 for each dealership, and to define fonts and colors that are used. The fonts and colors may be selected to match corporate branding associated with the Smith Motor Company.

In another example, a user may desire to generate an alien theme 150 and would like to include features on the map 140 that correspond to supposed alien encounters. The user may use the customization engine 210 to create a custom feature 153 that can be used to represent alien encounters on the map 140. The user may use the customization engine 210 to define custom attributes 155 such an image of alien head, and to define fonts and colors that are futuristic and that suggest outer space.

With respect to custom attributes 155, the customization engine 210 may allow the user to create or define custom attributes 155 for each feature 143 (or custom feature 153). A custom attribute 155 may be an attribute that is different than the stock or default attributes 145 used by the map 140. Custom attributes 155 may include icons or graphics, colors, fonts, sizes, and animations for example. Other attributes may be supported.

In some implementations, the customization engine 210 may display some or all of the features 143 associated with a map 140, and the user may select the feature 143 (or custom feature 153) that the user would like to change one or more associated attributes 145. The user may be provided with a list of the attributes 145 that are associated with the selected feature 143 and an option to select the attribute 145 that they would like to change.

For example, a user may desire to select a custom attribute 155 for a feature 143 corresponding to parks. The customization engine 210 may display multiple textures and/or colors that the user can select as a custom attribute 155 to replace the attribute 145 that is the default color and/or texture that is used to display parks on the map 140. The user can select one of the displayed textures and/or colors, or may provide their own texture and/or color. For example, the user may upload an image of leaves that the user would like to be used as a custom attribute 155 for the park feature 143.

The customization engine 210 may also allow the user to create a temporal condition 247, and to associate the temporal condition 247 with the theme 150, or with one or more custom features 153 or custom attribute 155. A temporal condition 247 may be a time or date that the associated theme 150, custom feature 153, or custom attribute 155, is active. The temporal condition 247 may be a single date or time, or may be a range of dates or times. Depending on the implementation, a theme 150 may be associated with multiple temporal conditions 247.

For example, a user may desire to create a Christmas theme 150. Accordingly, the user may associate the theme 150 with a temporal condition 247 that the theme 150 only be active within the date range of December 15 to December 31. When the user uses the map 140 on a date that is outside of the date range of the temporal condition 247 (e.g., December 14), the map 140 may be displayed with the default features 143 and attributes 145. However, when the user views the map 140 on a date that is inside the range of the temporal condition 247 (e.g., December 21), the map 140 may be displayed with the custom features 153 and/or custom attributes 155.

In another example, a user may desire to create a seasons theme 150. Accordingly, the user may associate the theme 150 with a temporal condition 247 for each of the four seasons. Each of the temporal conditions 247 may be associated with custom features 153 and/or custom attributes 155 that correspond to the associated season. For example, the winter season may be associated with a temporal condition 247 of December 21-March 20, and custom attributes 155 such as snow or ice graphics. The fall season may be associated with a temporal condition 247 of September 22-December 20, and custom attributes 155 such as leaf graphics. The spring and summer seasons may be similarly associated with temporal conditions 247 and custom attributes 155.

As described above, temporal conditions 247 may also be associated with individual custom features 153 and/or custom attributes 155. Continuing the Christmas example above, the user may associate a custom feature 153 that purports to show the location of Santa Claus on the map 140. The custom feature 153 may be associated with the temporal condition 247 that the feature only be displayed on December 24. When the user uses the map 140 on a date that does not satisfy the temporal condition 247 (e.g., December 14), the map 140 may be displayed without the Santa Claus feature 153. However, when the user views the map 140 on a date that satisfies the temporal condition 247 (e.g., December 24), the map 140 may be displayed with the Santa Claus feature 153.

Temporal conditions 247 may similarly be associated with custom attributes 155. For example, a user may make a “dark” custom attribute 155 for a road that is only active when the current time is during the night, and the user may make a “light” custom attribute for the road that is only active when the current time is during the day.

Other types of conditions may be associated with each theme 150, custom feature 153, and custom attribute 155. For example, there may be a weather condition that changes the appearance of the map 140 depending on whether it is raining or snowing, or there may be a smog condition that changes the appearance of the map 140 based on the current smog levels of a location.

The sharing engine 220 may allow users to share themes 150 that they have created with other users. For example, the sharing engine 220 may allow a user to share a theme 150 with their friends, or contacts in a social network. In another example, the sharing engine 220 may allow the user to share a generated theme 150 with family members. Any method for providing files or data may be used by the sharing engine 220 to share themes 150 including e-mail and text messaging applications.

The sharing engine 220 may also provide a marketplace type environment where users may browse themes 150 that are available for download, and may provide themes 150 for other users to download. Depending on the implementation, the sharing engine 220 may provide a user interface that displays themes 150 that have been uploaded or provided by users. The user interface may also allow users to search for themes 150 by providing specific keywords, may allow users to browse themes 150 by category, and may allow users to browse themes 150 produced by specific users or corporations.

The sharing engine 220 may allow users to assign ratings 225 to one or more themes 150. Depending on the implementation, a rating 225 may be a numerical rating 225 that is associated with a scale such as 1-5 or 1-10. Any type of rating 225 may be used. The received ratings 225 for each theme 150 may be stored with the theme 150 in the theme storage 170. Some or all of the received ratings 225 for a theme 150 may be used by the sharing engine 220 to calculate an average rating 225 for the theme 150. The average ratings 225 for the themes 150 may be used to filter or sort available themes 150 by the users.

The sharing engine 220 may allow users to receive compensation 227 for the themes 150 that they make available on the marketplace. For example, some of the themes 150 may require (or suggest) that the user pay a fee to download and use the theme 150. After a user downloads a theme 150 associated with a fee, the fee may be collected by the sharing engine 220. Some or all of the collected fee may be distributed to the owner or creator of the downloaded theme 150 as the compensation 227.

As may be appreciated, the sharing engine 220 as described herein allows for several usage scenarios. One such scenario is corporate branding. For example, a corporation such as a coffee shop may provide a free theme 150 with custom attributes 155 that correspond to colors and fonts used in a current advertising campaign. The theme 150 may identify locations of the coffee shop on the map 140 using custom features 153. The theme 150 may include custom features 153 such as coupons that the user can select to redeem as an incentive for using the theme 150.

Another scenario is for guided tours. For example, on a guided tour of a city, the participants in the tour may be provided a theme 150 that uses custom attributes 155 corresponding to the corporate branding of the tour company, and that includes custom features 153 for each location that the user visits on the tour. The custom features 153 may include information about each location or an embedded link to a website where more information about a particular location can be found. The theme 150 may be used during the tour in combination with the map 140 to orient the user, and may be viewed after the tour as a keepsake or reminder of the tour.

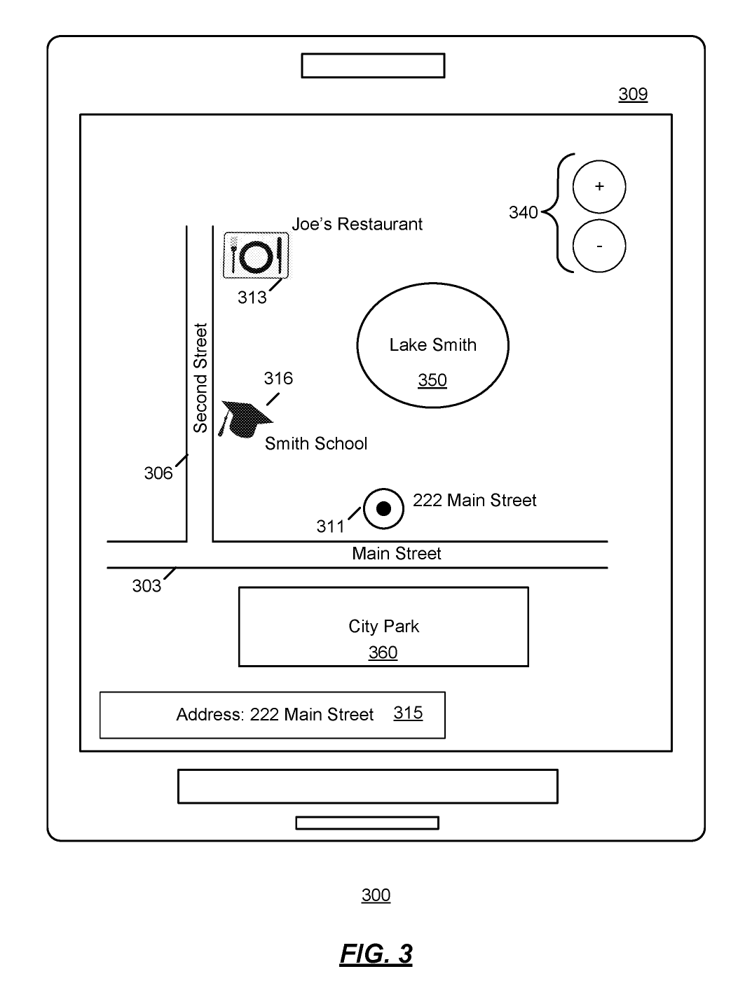

FIG. 3 is an illustration of an example user interface 300 for viewing a map 140. The user interface 300 may be implemented by a map client 113 executing on a client device 110. As shown, the user interface 300 is displayed on a tablet computing device. However, the user interface 300 may also be displayed by other computing devices such as smart phones and vehicle navigation systems.

As shown in a window 309, a user is viewing a map 140. The map 140 corresponds to an area surrounding the address “222 Main street” that was provided by the user in a text box 315.

The map 140 includes a plurality of features 143. In the example shown, the map 140 includes a road 303 labeled “Main Street” and a road 306 labeled “Second Street”. The map further includes a school 316 labeled “Smith School”, a restaurant 313 labeled “Joe's Restaurant”, a lake 350 labeled “Lake Smith”, a park 360 labeled “City Park”, and zoom tools 340. The map 140 shows an origin 311 labeled “222 Main street” that corresponds to the address selected in the text box 315. Other features 143 may be included in the map 140.

Each of the displayed features 143 is associated with one or more attributes 145. In the example shown, the features 143 are displayed with the same font. The school 316 is associated with an attribute 145 that is an image of a graduation cap. The restaurant 313 is associated with an attribute 145 that is an image of a place setting. The origin 311 is associated with an attribute 145 that is an image of a target. Each of the lake 350, the city park 360, the road 303, and the road 306 are associated with an attribute 145 that is the color white. The zoom tool 340 is associated with icons having the “+” and “−” symbols representing the zoom in and zoom out operations.

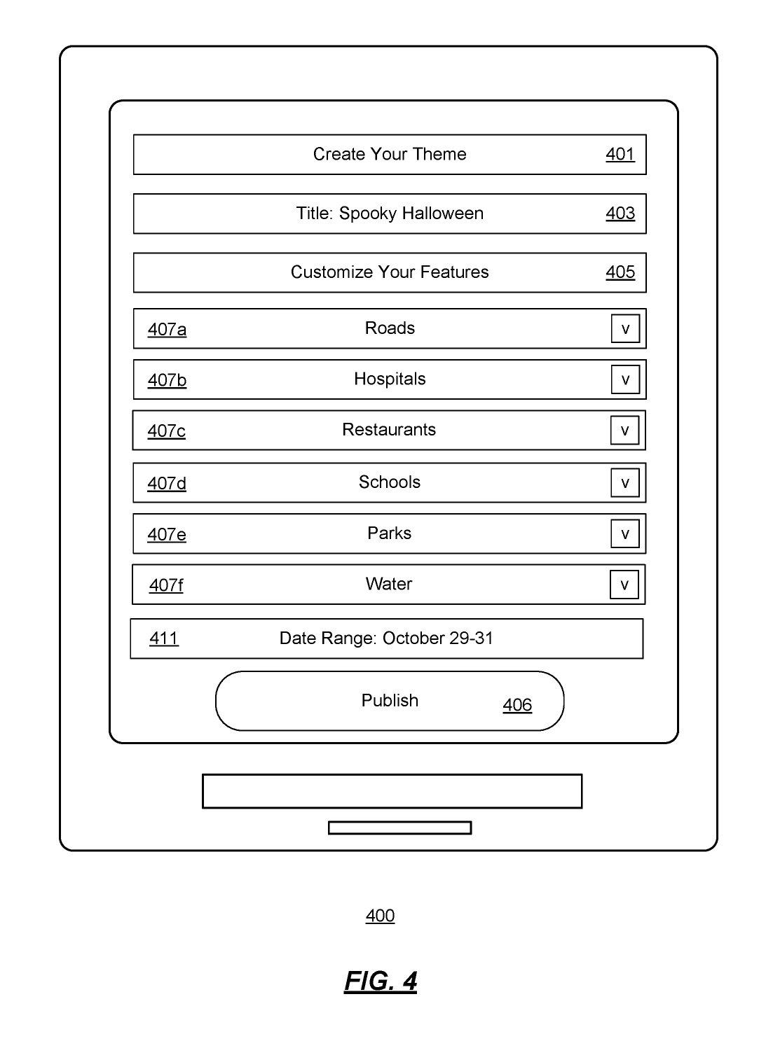

FIG. 4 is an illustration of an example user interface 400 that may be used to generate a theme 150 for a map 140. The user interface 400 may be displayed by a map client 113 executing on a client device 110, and may be provided by the customization engine 210 of the map engine 165. As shown, the user interface 400 is displayed on a tablet computing device. However, the user interface 400 may also be displayed by other computing devices such as smart phones and vehicle navigation systems.

As may be appreciated, the various features 143 and attributes 145 shown in the window 309 represent the default or stock map 140 with no themes 150. To create a custom theme 150, the user may connect to the map engine 165 using the user interface 400.

As shown, the user interface 400 includes a text box 401 that instructs the user to “Create Your Theme”. The user may desire to create a Halloween theme 150 and has entered the title “Spooky Halloween” for the theme 150 into a text box 403.

The user interface 400 includes a text box 405 that instructs the user to “Customize your Features” and includes a plurality of user interface elements 407 that each correspond to a different feature 143 that may be customized. In the example shown, the user interface includes a user interface element 407a corresponding to the feature 143 “Roads”, a user interface element 407b corresponding to the feature 143 “Hospitals”, a user interface element 407c corresponding to the feature 143 “Restaurants”, a user interface element 407d corresponding to the feature 143 “Schools”, a user interface element 407e corresponding to the feature 143 “Parks”, and a user interface element 407f corresponding to the feature 143 “Water”. Other features 143 may be included in the user interface 400.

In addition, the user interface 400 includes a text box 411 where the user can provide a temporal condition 247. In the example shown, the user has provided the date range October 29-31 as the temporal condition 247. In other implementations, multiple temporal conditions 247, or no temporal conditions 247, may be supported.

The user may select a feature 143 to provide a custom attribute 155 by selecting one of the user interface elements 407. Once the user has completed their theme 150, they may provide the completed theme 150 to the map engine 165 by selecting or touching the user interface element 406 labeled “Publish”.

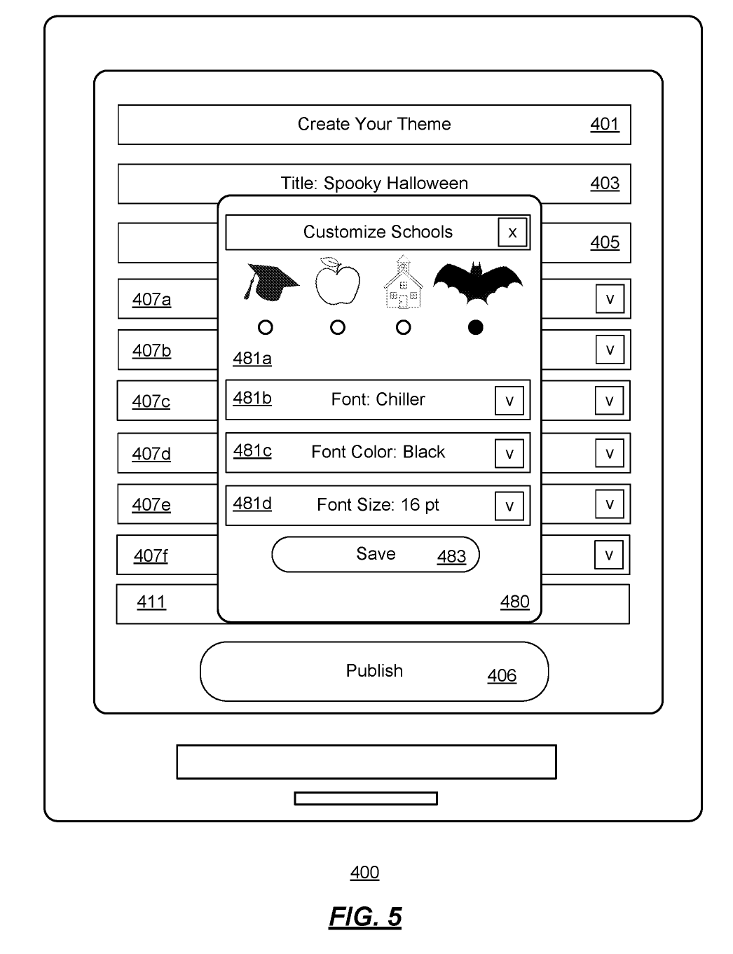

Continuing to FIG. 5, the user has selected user interface element 407d corresponding to the feature 143 “Schools”. In response, the map engine 165 has provided a window 480 in the user interface 400 that the user can use to provide one or more custom attributes 155 using the user interface elements 481. In the example shown, for the icon attribute 155, the user has selected an image of the bat using the user interface element 481a. For the font attribute 155, the user has selected a font called “Chiller” using the user interface element 481b. For the font color attribute 155, the user has selected a font color “Black” using the user interface element 481c. For the font size attribute 155, the user has selected to font size “16 pt” using the user interface element 481d. Other attributes 155 may be customized.

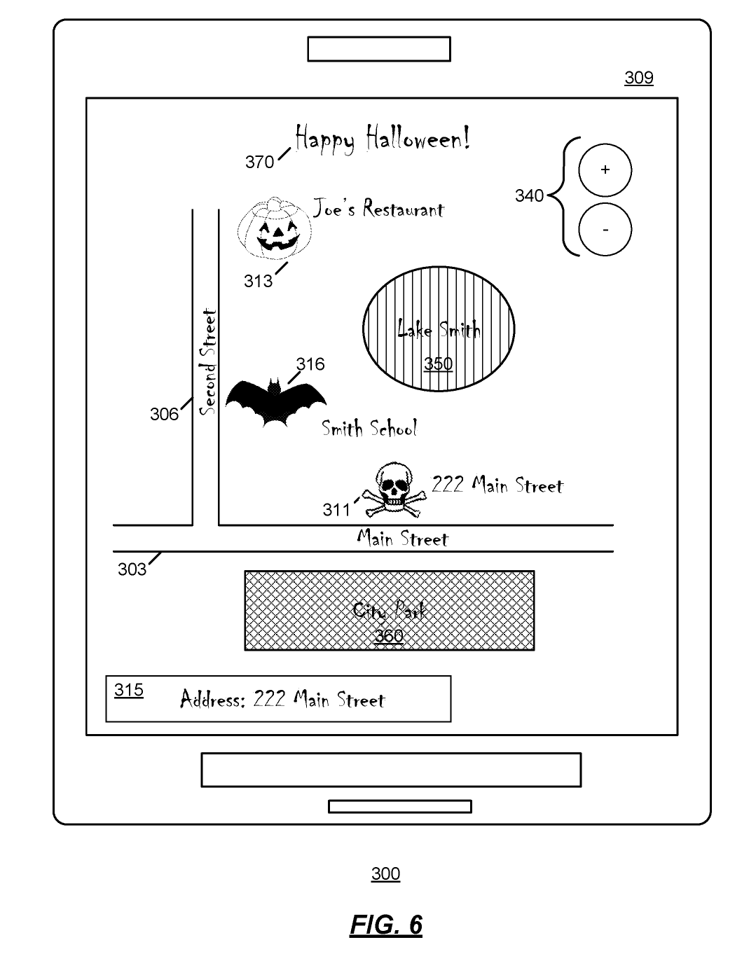

Continuing to FIG. 6, the user has completed the theme 150, and the theme 150 has been used to display the map 140 shown in the window 309. As shown, the user has provided custom attributes 145 for the icons associated with the school 316, the restaurant 313, and the origin 311. For example, the school 316 is now associated with a bat icon, the restaurant 313 is now associated with a pumpkin icon, and the origin 311 is now associated with a skull and crossbones icon.

Similarly, all the fonts used in the map 140 has been changes to the font “Chiller”. Moreover, the fill of the lake 350 and the park 360 have been changed to represent a custom attribute 155 related to the colors used in the features 143. No changes were made to the attributes 155 of the zoom tool 340.

The map 140 now also includes at least one custom feature 153. For example, the map 140 includes a banner 370 that includes the text “Happy Halloween!”.

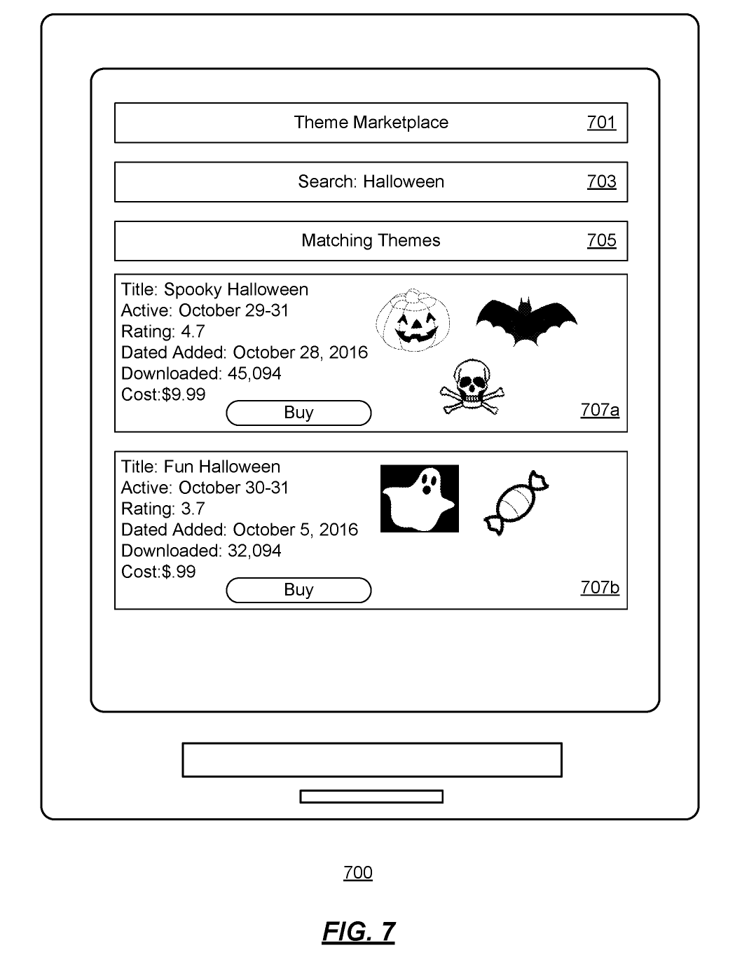

FIG. 7 is an illustration of an example user interface 700 for browsing and downloading themes 150. The user interface 700 may be displayed by a map client 113 executing on a client device 110, and may be provided by the sharing engine 220 of the map engine 165. As shown, the user interface 700 is displayed on a tablet computing device. However, the user interface 700 may also be displayed by other computing devices such as smart phones and vehicle navigation systems.

The user interface 700 includes a text box 401 that indicates that the user interface 700 is part of the “Theme Marketplace”. The user has provided the search term “Halloween” into the text box 703 to search for available themes 150 that are associated with Halloween. While not shown, other criteria may be used to discover relevant themes 150. For example, the user may be able to browse themes 150 by criteria such as subject matter, most downloaded, newest, average rating 225, cost, and author, etc.

In response to the search term, the sharing engine 220 has provided two relevant themes 150 that are shown in the windows 707 under a text box 705 labeled “Matching Themes”. A theme 150 titled “Spooky Halloween” is shown in the window 707a, and a theme 150 titled “Fun Halloween” is shown in the window 707b.

Shown in the window 707 associated with each theme 150 are various details about the theme 150 that may help the user select a theme 150. For example, each window 707 includes the title of the theme 150 (“Title”), the temporal condition 247 associated with the theme 150 (“Active”), the average rating 225 received for the theme 150 (“Rating”), the date when the theme 150 was uploaded (“Date Added”), the number of times that the theme 150 was downloaded (“Downloaded”), and the cost to download the theme 150 (“Cost”). Other information may be provided.

In addition, shown in each window 707 are some example images and/or icons used in the associated theme 150. While not shown, in some implementations, each window 707 may include a screen shot of an example map 140 using the associated theme 150. If the user desires to download a theme 150 associated with a window 707, the user may select the user interface element labeled “Buy”.

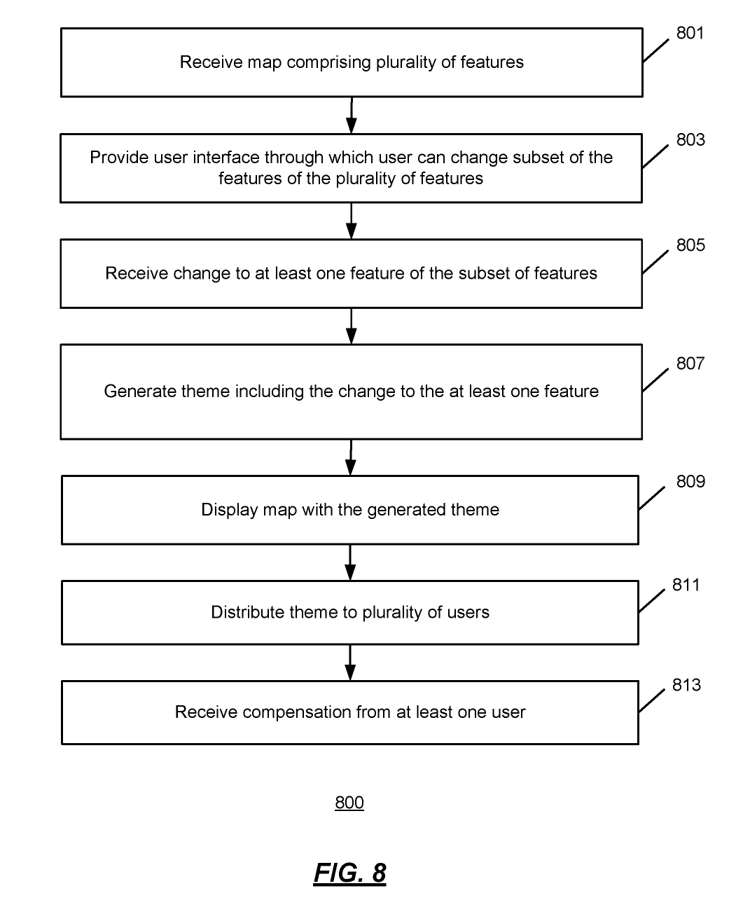

FIG. 8 is an operational flow of an implementation of a method 800 for generating a theme for a map, and distributing the theme on a theme marketplace. The method 800 may be implemented by the map engine 165 and/or the map client 113.

At 801, a map comprising a plurality of features is received. The map 140 may be received by the map client 113 from the map engine 165. The features 143 of the map 140 may include geographic features (e.g., mountains, rivers, lakes, parks, forests, etc.), roads (e.g., highways, local roads, etc.), places of interest (e.g., landmarks, tourist attractions, etc.), and businesses (e.g., coffee shops, restaurants, bars, drug stores, etc.).

Each feature 143 may further comprise a plurality of attributes 145. The attributes 145 associated with a feature 143 may control how the feature 143 is displayed or rendered on the map 140. Examples of attributes 145 may include colors, fonts, icons, and sounds. Other types of attributes 145 may be supported.

At 803, a user interface is provided through which a user can change a subset of the features of the plurality of features. The user interface may be provided by the customization engine 210 of the map engine 165. An example user interface is the user interface 400 of FIG. 4 and FIG. 5. The user interface may be displayed to the user associated with the client device by the map client 113. The user interface may be a complex interface that allows advanced users to change all, or almost all, of the features 143 associated with the map 140. Alternatively, the user interface may be a simplified user interface that allows less sophisticated users to change a subset of features 143 such as colors.

At 805, a change to at least one feature of the subset of features is received. The change may be received by the customization engine 210 of the map engine 165. For example, a user may use the customization engine 210 to make a change to at least one feature 143 by changing an attribute 145 associated with the at least one feature 143 to a custom attribute 155. For example, the user may change the icon or graphic associated with the at least one feature 143 to a custom graphic or icon.

At 807, a theme is generated using the change to the at least one feature. The theme 150 may be generated by the customization engine 210 of the map engine 165. Depending on the implementation, the theme 150 may be stored by the map engine 165 in the theme storage 160.

At 809, the map is displayed with the generated theme. The map 140 may be displayed with the generated theme 150 by the map client 113 and/or the map engine 165. In some implementations, the map 140 may be displayed by replacing the features 143 and attributes 145 with custom features 153 and/or custom attributes 155 associated with the theme 150.

At 811, the theme is distributed to a plurality of users. The theme 150 may be distributed to a plurality of users by the sharing engine 220 of the map engine 165. The theme 150 may be shared by the sharing engine in a theme marketplace where users can view and download available themes 150.

At 813, compensation for the theme is received from at least one user of the plurality of users. The compensation 227 may be provided by the sharing engine 220 of the map engine 165. The compensation 227 may have been received from the at least one user of the plurality of users that downloaded the theme 150 from the theme marketplace provided by the sharing engine 220, for example.

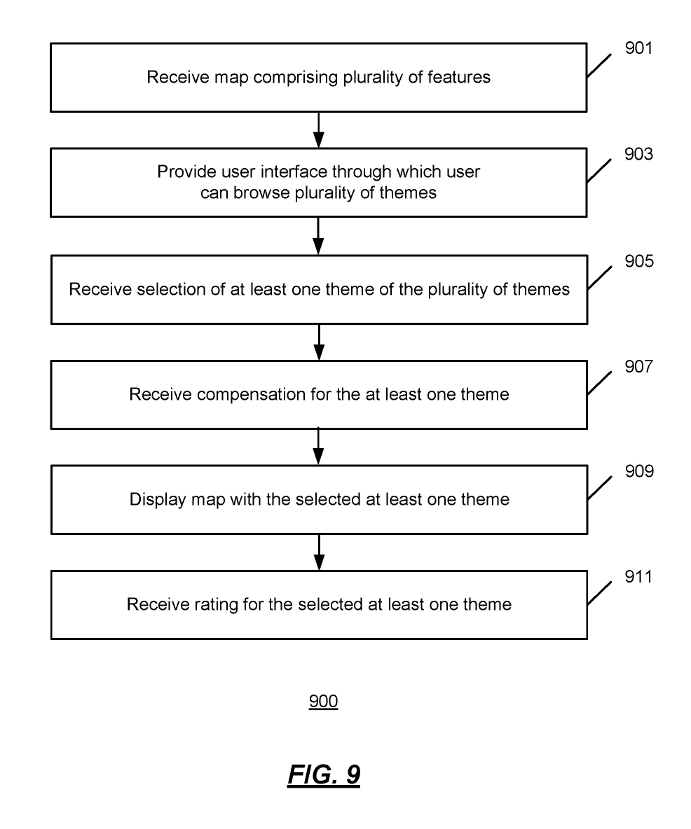

FIG. 9 is an operational flow of an implementation of a method 900 for selecting a theme for a map from a theme marketplace, and for displaying the map with the selected theme. The method 900 may be implemented by the map engine 165 and/or the map client 113.

At 901, a map comprising a plurality of features is received. The map 140 may be received by the map client 113 from the map engine 165. Each feature 143 may comprise a plurality of attributes 145.

At 903, a user interface is provided through which a user can browse a plurality of themes. The user interface may be provided by the sharing engine 220 of the map engine 165. An example user interface is the user interface 700 of FIG. 7. The user interface may be part of the theme marketplace where users can browse and search for available themes 150.

At 905, a selection of at least one theme of the plurality of themes is received. The selection may be received by the sharing engine 220 of the map engine 165 through the user interface. For example, a user browsing the theme marketplace may select at least one theme 150, and the selection may be provided to the sharing engine 220.

At 907, compensation for the selected at least one theme is received. The compensation 227 may be received by the sharing engine 220 of the map engine 165 from the user that selected the at least one theme 150.

At 909, the map is displayed with the selected at least one theme. The map 140 may be displayed with the selected theme 150 by the map client 113 and/or the map engine 165. In some implementations, the map 140 may be displayed by replacing the features 143 and attributes 145 with and custom features 153 and/or the custom attributes 155 associated with the selected theme 150.

At 911, a rating for the selected at least one theme is received. The rating 225 may be received by the sharing engine 220 of the map engine 165 from the user that selected the at least one theme 150. The rating 225 may be an indicator how satisfied the user is with the selected at least one theme 150. Depending on the implementation, the sharing engine 220 may use the received rating 225 to update an average rating 225 that is associated with the selected at least one theme 150.

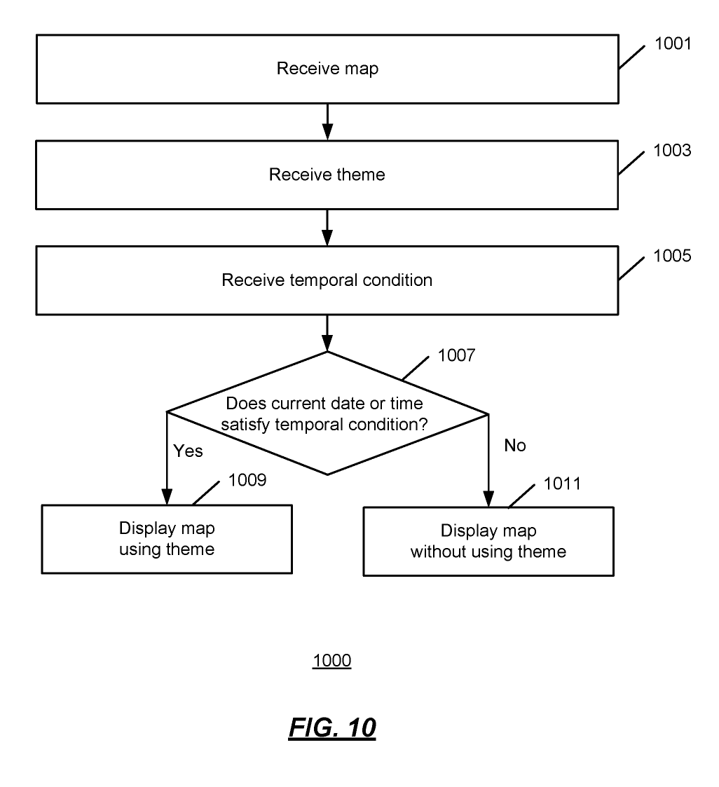

FIG. 10 is an operational flow of an implementation of a method 1000 for displaying a map with or without a received theme based on a temporal condition. The method 1000 may be implemented by the map engine 165 and/or the map client 113.

At 1001, a map comprising a plurality of features is received. The map 140 may be received by the map client 113 from the map engine 165. Each feature 143 may comprise a plurality of attributes 145.

At 1003, a theme is received. The theme 150 may be received by the map client 113 from the map engine 165. The theme 150 may have been selected by a user from a plurality of themes 150 made available by the sharing engine 220 of the map engine 165 at a theme marketplace. The received theme 150 may include one or more custom features 153 and/or custom attributes 155.

At 1005, a temporal condition is received. The temporal condition 247 may be received by the map client 113 from the map engine 165. The temporal condition 247 may be a date or time, or a range of dates or times, that the theme 150 is active for. Depending on the implementation, some or all of the custom features 153 and/or custom attributes 155 may similarly be associated with temporal conditions 247 that control when the associated custom features 153 and/or custom attributes 155 are active.

At 1007, whether the current date or time satisfies the temporal condition is determined. The determination may be made by the map engine 113 and/or the map engine 165. For example, if the temporal condition 247 is between 5 pm and 7 am, and the current time is 6 pm, then the temporal condition 247 is satisfied. In another example, if the temporal condition 217 is Saturday, and the current time is 5 pm on Friday, then the temporal condition 247 is not satisfied. If the temporal condition 247 is satisfied, the method 1000 may continue at 1009. If the temporal condition 247 is not satisfied, the method 1000 may continue at 1011.

At 1009, the map is displayed using the received theme. The map 140 may be displayed with the received theme 150 by the map client 113 and/or the map engine 165. Depending on the implementation, the map 140 may be displayed by replacing the features 143 and attributes 145 with custom features 153 and/or custom attributes 155 associated with the received theme 150.

At 1011, the map is displayed without using the received theme. The map 140 may be displayed without using the received theme 150 by the map client 113 and/or the map engine 165. Where the received temporal condition 247 is associated with the entire theme 150, the map 140 may be displayed using the original features 143 and attributes 145 associated with the received map 140. Where the received temporal condition 247 is associated with a subset of the custom features 153 and/or custom attributes 155 of the theme 150, the map 140 may be displayed using the custom features 153 and/or custom attributes 155 of the theme 150 that are not associated with the temporal condition 247. For the custom features 153 and/or custom attributes 155 of the theme 150 that are associated with the temporal condition 247, the original features 143 and attributes 145 of the map 140 may be displayed.

FIG. 11 shows an exemplary computing environment in which example embodiments and aspects may be implemented. The computing device environment is only one example of a suitable computing environment and is not intended to suggest any limitation as to the scope of use or functionality.

Numerous other general purpose or special purpose computing devices environments or configurations may be used. Examples of well-known computing devices, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 11, an exemplary system for implementing aspects described herein includes a computing device, such as computing device 1100. In its most basic configuration, computing device 1100 typically includes at least one processing unit 1102 and memory 1104. Depending on the exact configuration and type of computing device, memory 1104 may be volatile (such as random access memory (RAM)), non-volatile (such as read-only memory (ROM), flash memory, etc.), or some combination of the two. This most basic configuration is illustrated in FIG. 11 by dashed line 1106.

Computing device 1100 may have additional features/functionality. For example, computing device 1100 may include additional storage (removable and/or non-removable) including, but not limited to, magnetic or optical disks or tape. Such additional storage is illustrated in FIG. 11 by removable storage 1108 and non-removable storage 1110.

Computing device 1100 typically includes a variety of computer readable media. Computer readable media can be any available media that can be accessed by the device 1100 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 1104, removable storage 1108, and non-removable storage 1110 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 1100. Any such computer storage media may be part of computing device 1100.

Computing device 1100 may contain communication connection(s) 1112 that allow the device to communicate with other devices. Computing device 1100 may also have input device(s) 1114 such as a keyboard, mouse, pen, voice input device, touch input device, etc. Output device(s) 1116 such as a display, speakers, printer, etc. may also be included. All these devices are well known in the art and need not be discussed at length here.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

In an implementation, a system for customizing map features, generating a theme using the customized features, and for distributing the theme is provided. The system includes at least one computing device and a map engine. The map engine may be adapted to: receive a map comprising a plurality of features, wherein each feature comprises a plurality of attributes; provide a user interface through which a user can change a subset of the features of the plurality of features; receive a change to at least one feature of the subset of features, wherein the change includes at least one custom attribute; generate a theme including the change to the at least one feature; and display the map with the generated theme.

Implementations may include some or all of the following features. The map engine may be further adapted to distribute the theme to a plurality of users. The map engine may be further adapted to receive compensation for the theme from at least one user of the plurality of users. The plurality of features may include one or more of geographic features, roads, places of interest, and businesses. The attributes may include one or more of colors, fonts, icons, and sounds. The at least one custom attribute may be associated with a temporal condition. The map engine adapted to display the map with the generated theme may include the map engine adapted to: when a current date or time matches the temporal condition, display the map with the at least one feature of the subset of features using the at least one custom attribute; and when the current date or time does not match the temporal condition, display the map with the at least one feature of the subset of features without using the at least one custom attribute.

In an implementation, a system for customizing map features, generating a theme using the customized features, and for distributing the theme is provided. The system may include at least one computing device and a map engine. The map engine may be adapted to: receive a map comprising a plurality of features, wherein each feature comprises a plurality of attributes; provide a user interface through which a user can browse a plurality of themes, wherein each theme comprises a change to at least one feature of the subset of features, and wherein the change includes at least one custom attribute for the at least one feature; receive a selection of at least one theme of the plurality of themes; and display the map with the selected at least one theme.

Implementations may include some or all of the following features. The map engine may be further adapted to receive compensation for the selected at least one theme. The plurality of features may include one or more of geographic features, roads, and places of interest. The attributes may include one or more of colors, fonts, icons, and sounds. The theme may be associated with a temporal condition. The map engine adapted to display the map with the selected at least one theme may include the map engine adapted to: when a current date or time matches the temporal condition, display the map with the selected at least one theme; and when the current date or time does not match the temporal condition, display the map without the selected at least one theme. The map engine may be further adapted to: provide a user interface through which the user can change a subset of the features of the plurality of features of the map; receive a change to at least one feature of the subset of features from the user; and generate a theme including the received change to the at least one feature. The map engine may be further adapted to add the generated theme to the plurality of themes.

In an implementation, a method for customizing map features, generating a theme using the customized features, and for distributing the theme is provided. The method includes: providing a user interface through which a user can change a subset of the features of a plurality of features of a map by a computing device, wherein each feature comprises a plurality of attributes; receiving a change to at least one feature of the subset of features by the computing device, wherein the change includes at least one custom attribute; generating a theme including the change to the at least one feature of the subset of features by the computing device, wherein the theme is associated with a temporal condition; and displaying the map with the generated theme by the computing device. Displaying the map by the computing device may include: when a current date or time satisfies the temporal condition, displaying the map with the at least one feature of the subset of features using the at least one custom attribute; and when the current date or time does not satisfy the temporal condition, displaying the map with the at least one feature of the subset of features without using the at least one custom attribute.

Implementations may include some or all of the following features. The method may further include distributing the generated theme to a plurality of users. The method may further include receiving compensation from at least one user of the plurality of users for the generated theme. The plurality of features may include one or more of geographic features, roads, and places of interest. The attributes may include one or more of colors, fonts, icons, and sounds.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A system for customizing map features, generating a theme using the customized features, and for distributing the theme, the system comprising:
at least one computing device; and
a map engine adapted to:
receive a map comprising a plurality of features, wherein each feature comprises a plurality of attributes;
provide a user interface through which a user can change a subset of the features of the plurality of features;
receive a change to at least one feature of the subset of features, wherein the change includes at least one custom attribute;
generate a theme including the change to the at least one feature; and
display the map with the generated theme.

2. The system of claim 1, wherein the map engine is further adapted to distribute the theme to a plurality of users.

3. The system of claim 2, wherein the map engine is further adapted to receive compensation for the theme from at least one user of the plurality of users.

4. The system of claim 1, wherein the plurality of features comprises one or more of geographic features, roads, places of interest, and businesses.

5. The system of claim 1, wherein the attributes comprise one or more of colors, fonts, icons, and sounds.

6. The system of claim 1, wherein the at least one custom attribute is associated with a temporal condition.

7. The system of claim 6, wherein the map engine adapted to display the map with the generated theme comprises the map engine adapted to:
when a current date or time matches the temporal condition, display the map with the at least one feature of the subset of features using the at least one custom attribute; and
when the current date or time does not match the temporal condition, display the map with the at least one feature of the subset of features without using the at least one custom attribute.

8. A system for customizing map features, generating a theme using the customized features, and for distributing the theme, the system comprising:
at least one computing device; and
a map engine adapted to:
receive a map comprising a plurality of features, wherein each feature comprises a plurality of attributes;
provide a user interface through which a user can browse a plurality of themes, wherein each theme comprises a change to at least one feature of the subset of features, and wherein the change includes at least one custom attribute for the at least one feature;
receive a selection of at least one theme of the plurality of themes; and
display the map with the selected at least one theme.

9. The system of claim 8, wherein the map engine is further adapted to receive compensation for the selected at least one theme.

10. The system of claim 8, wherein the plurality of features comprises one or more of geographic features, roads, and places of interest.

11. The system of claim 8, wherein the attributes comprise one or more of colors, fonts, icons, and sounds.

12. The system of claim 8, wherein the theme is associated with a temporal condition.

13. The system of claim 12, wherein the map engine adapted to display the map with the selected at least one theme comprises the map engine adapted to:
when a current date or time matches the temporal condition, display the map with the selected at least one theme; and
when the current date or time does not match the temporal condition, display the map without the selected at least one theme.

14. The system of claim 8, wherein the map engine is further adapted to:
provide a user interface through which the user can change a subset of the features of the plurality of features of the map;
receive a change to at least one feature of the subset of features from the user; and
generate a theme including the received change to the at least one feature.

15. The system of claim 14, wherein the map engine is further adapted to add the generated theme to the plurality of themes.

16. A method for customizing map features, generating a theme using the customized features, and for distributing the theme, the method comprising:
providing a user interface through which a user can change a subset of the features of a plurality of features of a map by a computing device, wherein each feature comprises a plurality of attributes;
receiving a change to at least one feature of the subset of features by the computing device, wherein the change includes at least one custom attribute;
generating a theme including the change to the at least one feature of the subset of features by the computing device, wherein the theme is associated with a temporal condition; and
displaying the map with the generated theme by the computing device by:
when a current date or time satisfies the temporal condition, displaying the map with the at least one feature of the subset of features using the at least one custom attribute; and
when the current date or time does not satisfy the temporal condition, displaying the map with the at least one feature of the subset of features without using the at least one custom attribute.

17. The method of claim 16, further comprising distributing the generated theme to a plurality of users.

18. The method of claim 17, further comprising receiving compensation from at least one user of the plurality of users for the generated theme.

19. The method of claim 16, wherein the plurality of features comprises one or more of geographic features, roads, and places of interest.

20. The method of claim 16, wherein the attributes comprise one or more of colors, fonts, icons, and sounds.
